(19) United States
(12) Patent Application Publication
(10) Pub. No.: US 2013/0051867 A1
(43) Pub. Date: Feb. 28, 2013

(54) DEVELOPER SUPPLY DEVICE AND IMAGE FORMING APPARATUS HAVING THE SAME

(71) Applicants: Suzue ONODA, Hikone (JP); Takanori UNO, Nisshin (JP)

(72) Inventors: Suzue ONODA, Hikone (JP); Takanori UNO, Nisshin (JP)

(73) Assignee: BROTHER KOGYO KABUSHIKI KAISHA, Aichi (JP)

(21) Appl. No.: 13/433,927

(22) Filed: Mar. 29, 2012

(30) Foreign Application Priority Data
Aug. 29, 2011 (JP) 2011-185488

(51) Int. Cl. G03G 15/08

(52) U.S. Cl. 399/281; 399/283

(57) ABSTRACT

A developer supply device is provided, which includes a developer retrieving member having a plurality of fibers extending from an outer circumferential surface of the developer retrieving member, the developer retrieving member being disposed in such a position that the fibers contact a developer carrying surface of a developer carrying body in a developer retrieving position downstream relative to a developer supply position in a moving direction of the developer carrying surface, the developer retrieving member being configured to rotate and retrieve the development agent from the developer carrying surface in the developer retrieving position by the fibers moving in contact with the developer carrying surface in response to the rotation of the developer retrieving member.

### CROSS-REFERENCE TO RELATED APPLICATION

This application claims priority under 35 U.S.C. §119 from Japanese Patent Applications No. 2011-185488 filed on Aug. 29, 2011. The entire subject matter of the application is incorporated herein by reference.

### BACKGROUND

1. Technical Field

The following description relates to one or more techniques for supplying charged development agent to an intended device.

2. Related Art

A developer supply device has been known that includes a developer carrying body (such as a development sleeve and a development roller) opposed to a photoconductive body to be supplied with development agent, and a retrieving roller configured to contact the developer carrying body from above so as to retrieve development agent (toner) from the surface of the developer carrying body.

### SUMMARY

In the known developer supply device, a large mechanical stress is applied to the development agent when the development agent is retrieved. Thus, it leads to a lowered ratio of reusable development agent to the retrieved development agent in the known developer supply device. On the other hand, when the known developer supply device is configured to keep the retrieving roller from contacting the developer carrying body so as to reduce the mechanical stress to the development agent to be retrieved, it results in insufficient efficiency for retrieving the development agent. Particularly, in an attempt to electrostatically retrieve the development agent in a non-contact manner, it is difficult to retrieve development agent charged with a reverse polarity (reversely-charged toner).

Aspects of the present invention are advantageous to provide one or more improved techniques for a developer supply device which techniques make it possible to retrieve development agent in a favorable manner and reuse the retrieved development agent in a favorable manner.

According to aspects of the present invention, a developer supply device configured to supply charged development agent to an intended device is provided, the developer supply device including a developer carrying body that includes a developer carrying surface which is a cylindrical circumferential surface of the developer carrying body, the developer carrying body being configured to rotate around a rotational axis in such a rotational direction that the developer carrying surface moves in a direction perpendicular to the rotational axis, the developer carrying body being disposed to face the intended device in a developer supply position, so as to supply the development agent carried on the developer carrying surface to the intended device in the developer supply position, an electric-field transfer unit configured to transfer, by a traveling-wave electric field, the development agent to a developer carrying position upstream relative to the developer supply position in the moving direction of the developer carrying surface, so as to make the developer carrying surface carry the development agent thereon in the developer carrying position, and a developer retrieving member including a plurality of fibers extending from an outer circumferential surface of the developer retrieving member, the developer retrieving member being disposed in such a position that the fibers contact the developer carrying surface in a developer retrieving position downstream relative to the developer supply position in the moving direction of the developer carrying surface, the developer retrieving member being configured to rotate and retrieve the development agent from the developer carrying surface in the developer retrieving position by the fibers moving in contact with the developer carrying surface in response to the rotation of the developer retrieving member.

According to aspects of the present invention, further provided is an image forming apparatus, which includes an image carrying body configured to carry an electrostatic latent image formed thereon, and a developer supply device configured to supply charged development agent to the image carrying body to develop the electrostatic latent image carried on the image carrying body. The developer supply device includes a developer carrying body including a developer carrying surface that is a cylindrical circumferential surface of the developer carrying body, the developer carrying body being configured to rotate around a rotational axis in such a rotational direction that the developer carrying surface moves in a direction perpendicular to the rotational axis, the developer carrying body being disposed to face the image carrying body in a developer supply position, so as to supply the development agent carried on the developer carrying surface to the image carrying body in the developer supply position, an electric-field transfer unit configured to transfer, by a traveling-wave electric field, the development agent to a developer carrying position upstream relative to the developer supply position in the moving direction of the developer carrying surface, so as to make the developer carrying surface carry the development agent thereon in the developer carrying position, and a developer retrieving member including a plurality of fibers extending from an outer circumferential surface of the developer retrieving member, the developer retrieving member being disposed in such a position that the fibers contact the developer carrying surface in a developer retrieving position downstream relative to the developer supply position in the moving direction of the developer carrying surface, the developer retrieving member being configured to rotate and retrieve the development agent from the developer carrying surface in the developer retrieving position by the fibers moving in contact with the developer carrying surface in response to the rotation of the developer retrieving member.

### BRIEF DESCRIPTION OF THE ACCOMPANYING DRAWINGS

FIG. 1 is a cross-sectional side view schematically showing a configuration of a laser printer in an embodiment according to one or more aspects of the present invention.

FIG. 2 is an enlarged cross-sectional side view of a toner supply device for the laser printer in the embodiment according to one or more aspects of the present invention.

FIG. 3 is an enlarged cross-sectional side view of an electric-field transfer board for the toner supply device in the embodiment according to one or more aspects of the present invention.

FIG. 4 exemplifies waveforms of voltages generated by power supply circuits for the electric-field transfer board in the embodiment according to one or more aspects of the present invention.

FIG. 5 shows an experimental result of a relationship between ratios of negatively charged toner and retrieving efficiencies in the embodiment according to one or more aspects of the present invention.

FIG. 6 shows an experimental result of a relationship between charge amounts of toner and frequencies (probability densities) of toner particles in the embodiment according to one or more aspects of the present invention.

FIG. 7 schematically shows a specific example of a partial configuration, of the toner supply device shown in FIG. 2, around a toner retrieving position in a modification according to one or more aspects of the present invention.

### DETAILED DESCRIPTION

It is noted that various connections are set forth between elements in the following description. It is noted that these connections in general and, unless specified otherwise, may be direct or indirect and that this specification is not intended to be limiting in this respect.

Hereinafter, an embodiment according to aspects of the present invention will be described with reference to the accompany drawings.

<Configuration of Laser Printer>

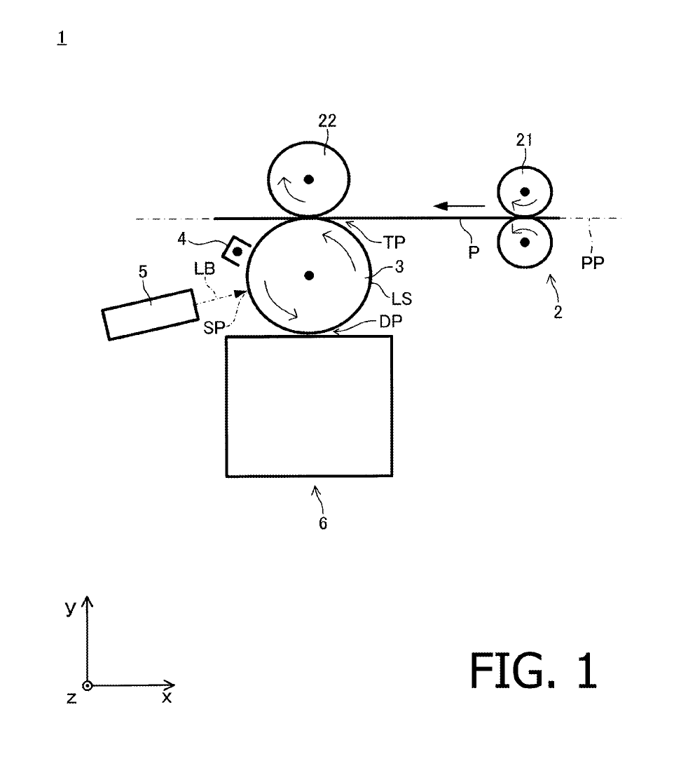

As illustrated in FIG. 1, a laser printer 1 includes a sheet feeding mechanism 2, a photoconductive drum 3, an electrification device 4, a scanning unit 5, and a toner supply device 6. The laser printer 1 further includes therein a feed tray (not shown) configured to accommodate sheets P stacked thereon. The sheet feeding mechanism 2 is configured to feed a sheet P along a predetermined sheet feeding path PP.

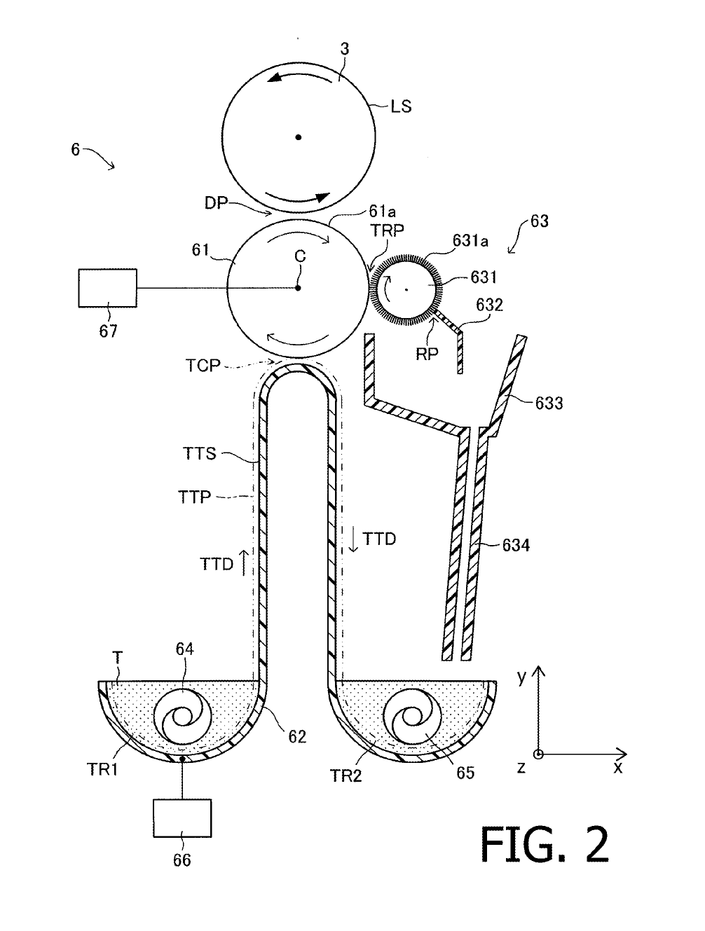

On a circumferential surface of the photoconductive drum 3, an electrostatic latent image carrying surface LS is formed as a cylindrical surface parallel to a main scanning direction (i.e., a z-axis direction in FIG. 1, which may be referred to as a “sheet width direction” or a “width direction” of the laser printer 1 as well). The electrostatic latent image carrying surface LS is configured such that an electrostatic latent image is formed thereon in accordance with an electric potential distribution. Further, the electrostatic latent image carrying surface LS is configured to carry toner T (see FIG. 2) in positions corresponding to the electrostatic latent image. The photoconductive drum 3 is driven to rotate in a counterclockwise direction indicated by arrows in FIG. 1 around an axis parallel to the main scanning direction. Thus, the photoconductive drum 3 is configured to move the electrostatic latent image carrying surface LS along an auxiliary scanning direction (typically, an x-axis direction in FIG. 1) perpendicular to the main scanning direction.

The electrification device 4 is disposed to face the electrostatic latent image carrying surface LS. The electrification device 4, which is of a corotron type or a scorotron type, is configured to evenly and positively charge the electrostatic latent image carrying surface LS.

The scanning unit 5 is configured to generate a laser beam LB modulated based on image data. Specifically, the scanning unit 5 is configured to generate the laser beam LB within a predetermined wavelength range, which laser beam LB is emitted under ON/OFF control depending on whether there is a pixel (an image element) in a target location on the image data. In addition, the scanning unit 5 is configured to converge the laser beam LB in a scanned position SP on the electrostatic latent image carrying surface LS and move (scan) the convergence point of the laser beam LB along the main scanning direction at a constant speed. Here, the scanned position SP is set to a position downstream relative to the electrification device 4 and upstream relative to the toner supply device 6 in a moving direction of the electrostatic latent image carrying surface LS moving in response to rotation of the photoconductive drum 3.

The toner supply device 6 is disposed under the photoconductive body 3 so as to face the electrostatic latent image carrying surface LS. The toner supply device 6 is configured to supply the positively charged toner T (see FIG. 2), in a development position DP (where the toner supply device 6 is opposed in closest proximity to the electrostatic latent image carrying surface LS), onto (the electrostatic latent image carrying surface LS of) the photoconductive drum 3. It is noted that in the embodiment, the toner T is positively-chargeable nonmagnetic-one-component black toner. A detailed explanation will be provided later about the configuration of the toner supply device 6.

Subsequently, a detailed explanation will be provided about a specific configuration of each of elements included in the laser printer 1.

The sheet feeding mechanism 2 includes two registration rollers 21, and a transfer roller 22. The registration rollers 21 are configured to feed a sheet P toward between the photoconductive drum 3 and the transfer roller 22 at a predetermined moment. The transfer roller 22 is disposed to face the electrostatic latent image carrying surface LS across the sheet feeding path PP in a transfer position TP. Additionally, the transfer roller 22 is driven to rotate in a clockwise direction indicated by an arrow in FIG. 1. The transfer roller 22 is connected with a transfer bias supply circuit (not shown), such that a predetermined transfer bias is applied to between the transfer roller 22 and the photoconductive drum 3 so as to transfer, onto the sheet P, the toner T (see FIG. 2) adhering onto the electrostatic latent image carrying surface LS.

<<Toner Supply Device>>

As shown in FIG. 2, which is a cross-sectional side view (a cross-sectional view along a plane with the main scanning direction as a normal line) showing the toner supply device 6 in an enlarged manner, the toner supply device 6 includes a development roller 61, an electric-field transfer board 62, a toner retrieving unit 63, augers 64 and 65, a transfer bias supply circuit 66, and a development bias supply circuit 67.

The development roller 61 is a roller-shaped member having a toner carrying surface 61a as a cylindrical circumferential surface thereof. The development roller 61 is opposed to the photoconductive drum 3 in the development position DP, so as to supply the toner T carried on the toner carrying surface 61a to the photoconductive drum 3 in the development position DP. The development roller 61 is driven to rotate around a center axis line C parallel to the main scanning direction (i.e., parallel to a generatrix of the toner carrying surface 61a), such that the toner carrying surface 61a moves in a direction perpendicular to the center axis line C. Specifically, the development roller 61 is driven to rotate in a direction (clockwise as indicated by arrows in FIG. 2) opposite to the rotational direction of the photoconductive drum 3, such that the toner carrying surface 61a moves in the same direction as the moving direction of the electrostatic latent image carrying surface LS in the development position DP.

The electric-field transfer board 62 is disposed to face the development roller 61 in a toner carrying position TCP, which is located upstream relative to the development position DP in the moving direction of the toner carrying surface 61a. Thus, the electric-field transfer board 62 allows the toner carrying surface 61a to carry thereon the toner transferred by the electric-field transfer board 62. The electric-field transfer board 62 is configured to transfer the toner T along a toner transfer path TTP (i.e., a transfer path for the toner T that is formed along a toner transfer surface TTS as a surface of the electric-field transfer board 62) by a traveling-wave electric field, which is generated when the electric-field transfer board 62 is supplied with a transfer bias containing a direct-current (DC) voltage component and multi-phase alternating-current (AC) voltage components. An internal configuration of the electric-field transfer board 62 will later be described in detail.

In the embodiment, the electric-field transfer board 62 is configured to transfer the toner T stored in a toner storage room TR1 toward the toner carrying position TCP, supply the toner T to the development roller 61 in the toner carrying position TCP, and transfer toner T that has passed through the toner carrying position TCP (toner T that has failed to be transferred to the development roller 61 in the toner carrying position TCP) to a toner storage room TR2 disposed adjacent to the toner storage room TR1. The electric-field transfer board 62 is formed to protrude toward the development roller 61 around the toner carrying position TCP.

Further, in the embodiment, the electric-field transfer board 62 includes a substantially flat section configured to transfer the toner T vertically up from the toner storage room TR1 toward the toner carrying position TCP, and a substantially flat section configured to transfer the toner T vertically down from the toner carrying position TCP toward the toner storage room TR2. Furthermore, the electric-field transfer board 62 is configured such that a toner transfer direction TTD (in which the toner is transferred on the toner transfer surface TTS) is opposite to the moving direction of the toner carrying surface 61a of the development roller 61 in the toner carrying position TCP.

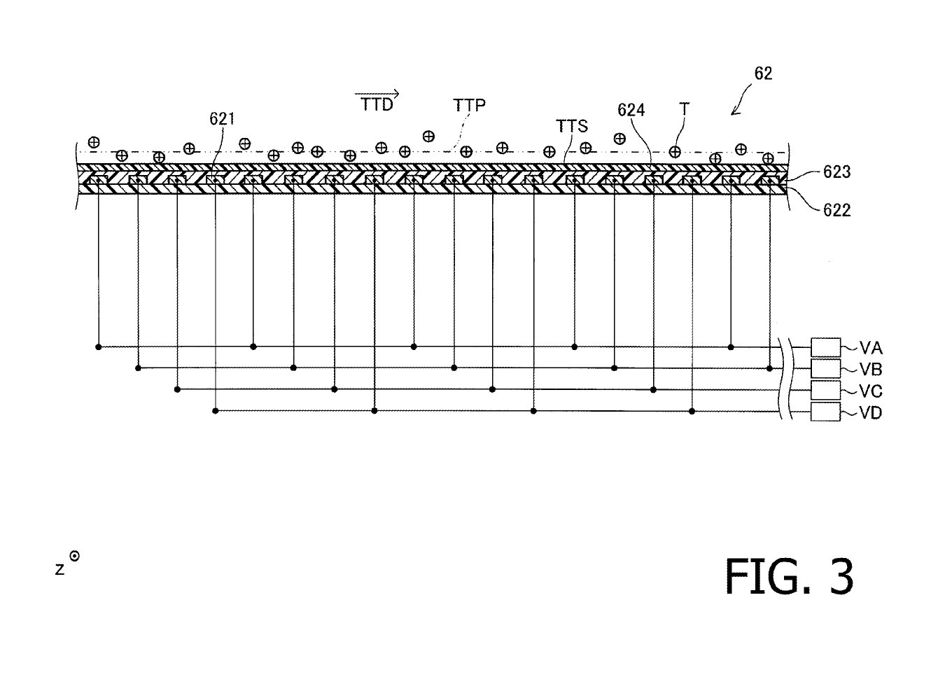

FIG. 3 is a cross-sectional side view showing the electric-field transfer board 62 in an enlarged manner. As shown in FIG. 3, the electric-field transfer board 62 is a thin plate member configured in the same manner as a flexible printed-circuit board. Specifically, the electric-field transfer board 62 includes a plurality of transfer electrodes 621, a transfer electrode supporting film 622, a transfer electrode coating layer 623, and a transfer electrode overcoating layer 624.

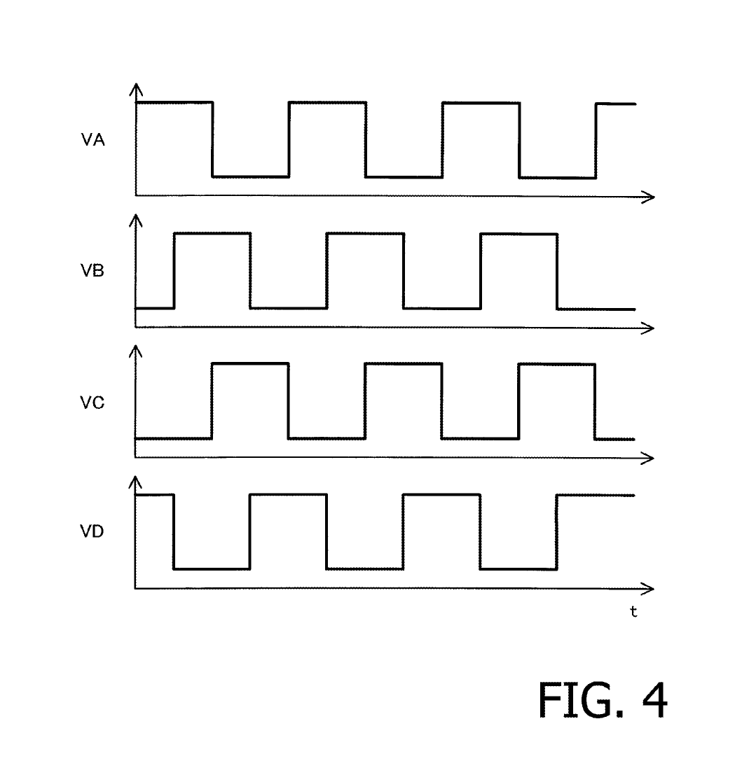

The transfer electrodes 621 are linear wiring patterns having a longitudinal direction parallel to the main scanning direction. The transfer electrodes 621 are formed, e.g., with copper thin films. The transfer electrodes 621 are arranged along the toner transfer path TTP in parallel with each other. Every fourth one of the transfer electrodes 621, arranged along the toner transfer path TTP, is connected with a specific one of four power supply circuits VA, VB, VC, and VD. In other words, the transfer electrodes 621 are arranged along the toner transfer path TTP in the following order: a transfer electrode 621 connected with the power supply circuit VA, a transfer electrode 621 connected with the power supply circuit VB, a transfer electrode 621 connected with the power supply circuit VC, a transfer electrode 621 connected with the power supply circuit VD, a transfer electrode 621 connected with the power supply circuit VA, a transfer electrode 621 connected with the power supply circuit VB, a transfer electrode 621 connected with the power supply circuit VC, a transfer electrode 621 connected with the power supply circuit VD, . . . . In the embodiment, as shown in FIG. 4, the power supply circuits VA, VB, VC, and VD are configured to generate respective AC driving voltages having substantially the same waveform. Further, the power supply circuits VA, VB, VC, and VD are configured to generate the respective AC driving voltages with a phase difference of 90 degrees between any adjacent two of the power supply circuits VA, VB, VC, and VD in the aforementioned order. In other words, the power supply circuits VA, VB, VC, and VD are configured to output the respective AC driving voltages each of which is delayed by a phase of 90 degrees behind the voltage output from a precedent adjacent one of the power supply circuits VA, VB, VC, and VD in the aforementioned order.

The transfer electrodes 621 are formed on a surface of the transfer electrode supporting film 622. The transfer electrode supporting film 622 is a flexible film made of polyimide resin. The transfer electrode coating layer 623 is provided to coat the transfer electrodes 621 and the surface of the transfer electrode supporting film 622 on which the transfer electrodes 621 are formed. In the embodiment, the transfer electrode coating layer 623 is made of polyimide resin. On the transfer electrode coating layer 623, the transfer electrode overcoating layer 624 is provided. The surface (the toner transfer surface TTS) of the transfer electrode overcoating layer 624 is formed to be a smooth surface with a very low level of irregularity, so as to smoothly convey the toner T thereon.

Referring back to FIG. 2, the retrieving unit 63 is configured to retrieve the toner T, which remains on the development roller 61 after having passed through the development position DP, from the toner carrying surface 61a by a brush roller 631 in a toner retrieving position TRP (downstream relative to the development position DP and upstream relative to the toner carrying position TCP in the moving direction of the toner carrying surface 61a). Further, the retrieving unit 63 is configured to convey the retrieved toner T toward the toner storage room TR2.

The brush roller 631 is a rotational body configured to retrieve the toner T from the toner carrying surface 61a in the toner retrieving position TRP. The brush roller 631 is opposed to the development roller 61 in the toner retrieving position TRP. The brush roller 631 includes a number of fibers 631a formed to radially extend from an outer circumferential surface thereof. Specifically, the brush roller 631 includes a metal roller made of metal such as aluminum, and nylon fibers (fiber size: 3 denier, fiber density: 120,000 fibers per inch squared, fiber length: 5 mm, and fiber resistance: 10⁵-10⁸ Ω·cm) provided to radially extend from a circumferential surface of the metal roller.

The brush roller 631 is disposed in such a position that the fibers 631a slightly bend while contacting the toner carrying surface 61a in the toner retrieving position TRP. Further, in the embodiment, the brush roller 631 is driven to rotate in the same direction (clockwise as indicated by an arrow in FIG. 2) as the rotational direction of the development roller 61. Thereby, in the toner retrieving position TRP, a moving direction of the fibers 631a is opposite to the moving direction of the toner carrying surface 61a.

The toner retrieving unit 63 includes a flicker 632, a toner receiver 633, and a toner transport tube 634, as well as the aforementioned brush roller 631. The flicker 632 is configured to remove, from the brush roller 631, the toner T retrieved from the toner carrying surface 61a by the brush roller 631. Specifically, the flicker 632 is configured to scrape off the toner T held by the fibers 631a while contacting the fibers 631a, moving in response to rotation of the brush roller 631, in a removing position RP located away from the toner retrieving position TRP.

The toner receiver 633 is disposed under the brush roller 631 and the flicker 632 (i.e., under the retrieving position RP), so as to receive the toner scraped off from the brush roller 631 in the retrieving position RP. The toner transport tube 634 is a tube-shaped member configured to transport the toner received by the toner receiver 633 down toward the toner storage room TR2. The toner transport tube 634 is formed integrally with (a bottom portion of) the toner receiver 633.

The toner storage room TR1 includes an auger 64 housed therein. Further, the toner storage room TR2 includes an auger 65 housed therein. The augers 64 and 65 are configured to, when driven to rotate, agitate and circulate the toner T in the toner storage rooms TR1 and TR2, respectively.

The electric-field transfer board 62 is electrically connected with the transfer bias supply circuit 66. The transfer bias supply circuit 66 is configured to output transfer biases (see FIG. 4) for transferring the toner T from the toner storage room TR1 to the toner storage room TR2 in the toner transfer direction TTD along the toner transfer path TTP.

The development roller 61 is electrically connected with the development bias supply circuit 67. The development bias supply circuit 67 is configured to output a voltage required for applying a development bias to between the development roller 61 and the photoconductive drum 3.

### <Operations and Effects>

Subsequently, an explanation will be provided about a general overview of operations and effects of the toner supply device 6 in the embodiment.

The positively charged toner T is transferred, by the electric-field transfer board 62, from the toner storage room TR1 to the toner carrying position TCP in the toner transfer direction TTD along the toner transfer path TTP. Then, the toner T is transferred onto and carried on the toner carrying surface 61a, which is the outer circumferential surface of the development roller 61, in the toner carrying position TCP.

The toner T, which has been transferred onto and carried on the development roller 61 in the toner carrying position TCP, is conveyed to the development position DP in response to the rotation of the development roller 61. Then, the toner T is supplied to the photoconductive drum 3 in the development position DP (in order to develop the electrostatic latent image formed on the electrostatic latent image carrying surface LS). The toner T, which remains on the toner carrying surface 61a after having passed through the development position DP, is removed (retrieved) from the toner carrying surface 61a by the brush roller 631 in the toner retrieving position TRP. Thereby, a development record (a trace of the toner T supplied to the photoconductive drum 3) formed in the development position DP is cleared in a favorable manner from the circumferential surface of the development roller 61 on which the toner T remains after having passed through the development position DP.

The toner T, retrieved from the toner carrying surface 61a by the brush roller 631 in the toner retrieving position TRP, is scraped off from the brush roller 631 (the fibers 631a) by the flicker 632, and then received by the toner receiver 633. The toner T received by the toner receiver 633 drops to the toner storage room TR2, and is retrieved by the toner storage room TR2. The toner T retrieved by the toner storage room TR2 is agitated together with toner T previously stored in the toner storage room TR2 and then resent to the toner storage room 1.

In the embodiment, the brush roller 631 rotates such that the fibers 631a moves in the direction opposite to the moving direction of the toner carrying surface 61a while contacting the toner carrying surface 61a in the toner retrieving position TRP. Thereby, it is possible to effectively reduce a mechanical stress to the toner T and retrieve the toner T (regardless of a charge state of the toner T) from the toner carrying surface 61a in a favorable manner. Thus, according to the embodiment, it is possible to retrieve and reuse the toner T with favorable efficiency.

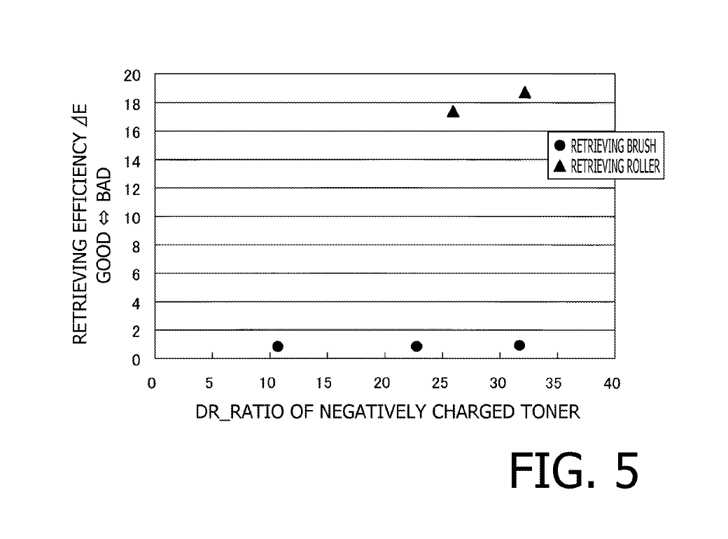

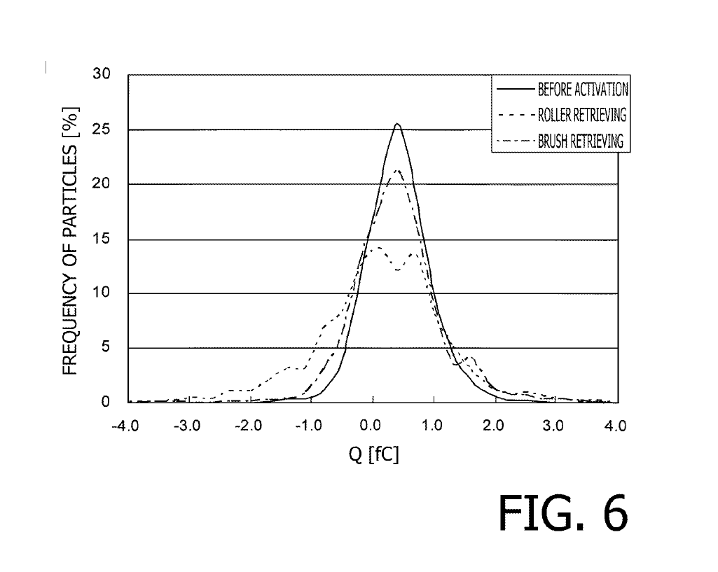

FIGS. 5 and 6 show results of experiments to verify how efficiently the toner retrieving unit 63 of the embodiment retrieves the toner T. Specifically, FIG. 5 shows a result of an experiment to examine a relationship between the retrieving efficiency and the ratio of negatively charged toner T (reversely charged toner T) on the toner carrying surface 61a using black toner for experimental use manufactured by BROTHER KOGYO KABUSHIKI KAISHA. FIG. 6 shows distributions of charge amounts of the retrieved toner T.

In FIG. 5, the parameter “retrieving efficiency” for the vertical axis is obtained in the following manner:

(1) attach a mending tape (manufactured by Sumitomo 3M Ltd.) onto the toner carrying surface 61a that has passed through the toner retrieving position TRP after one cycle of rotation of the development roller 61, and then remove the mending tape;
(2) attach the removed mending tape onto a regular paper (product name: “Berga Focus” manufactured by Stora Enso Oyj); and
(3) determine a difference ΔE between a reflecting density of the mending tape and a reflecting density of the white background of the paper (which are measured by a spectral photometer “Spectrolino” manufactured by Gretag-Macbeth Corporation).

The data for “retrieving roller” in FIG. 5 is obtained in an experiment to electrostatically retrieve the toner T using a retrieving roller, which is configured as a rigid body without the fibers 631a. Experimental conditions are shown as follows.
Transfer bias: +300 V to +900 V (DC component: +600 V, AC component: amplitude of 300 V, frequency of 300 Hz, four-phase AC voltage)
Development bias: +300 V
Retrieving bias (voltage applied to the brush roller 631 and the retrieving roller): 0 V

FIG. 6 shows distributions of charge amounts of the retrieved toner T that are measured by the Espart Analyzer (trademark registered) manufactured by HOSOKAWA MICRON CORPORATION. In FIG. 6, the data for “before activation” indicated by the solid line represents an experimental result for the toner T stored in the toner storage room TR1 in a state before electric-field transferring is started. The data for “brush retrieving” indicated by the alternate long and short dash line represents an experimental result for the toner T scraped off from the brush roller 631 by the flicker 632. The data for “roller retrieving” indicated by the dashed line represents an experimental result for the toner T scraped off from the retrieving roller by a blade.

As shown in FIG. 5, when the toner T is retrieved by the brush roller 631 of the embodiment (see “retrieving brush” in FIG. 5), good retrieving efficiencies are observed. Meanwhile, when the toner T is retrieved by the retrieving roller of the comparative example (see “retrieving roller” in FIG. 5), there are observed retrieving efficiencies worse than those for “retrieving brush.” Particularly, as the ratio of the negatively charged toner T rises, the retrieving efficiency for “retrieving roller” becomes worse.

Further, as shown in FIG. 6, the distribution of the charge amount of the toner T retrieved by the retrieving roller of the comparative example (see “roller retrieving” in FIG. 6) is remarkably different from that for “before activation.” This result is considered to reveal that when the toner T is retrieved by the retrieving roller, a relatively large mechanical stress is applied to the toner T, and thus the retrieved toner T is deteriorated. Meanwhile, the distribution of the charge amount of the toner T retrieved by the brush roller 631 of the embodiment (see “brush retrieving” in FIG. 6) is almost the same as that for “before activation.” This result is considered to reveal that when retrieved by the brush roller 631, the toner T is prevented from being deteriorated, as effectively as possible.

Hereinabove, the embodiment according to aspects of the present invention has been described. The present invention can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present invention. However, it should be recognized that the present invention can be practiced without reapportioning to the details specifically set forth. In other instances, well known processing structures have not been described in detail, in order not to unnecessarily obscure the present invention.

Only an exemplary embodiment of the present invention and but a few examples of their versatility are shown and described in the present disclosure. It is to be understood that the present invention is capable of use in various other combinations and environments and is capable of changes or modifications within the scope of the inventive concept as expressed herein. For example, the following modifications are possible.

<Modifications>

Aspects of the present invention may be applied to electrophotographic image forming apparatuses such as color laser printers, and monochrome and color copy machines, as well as the single-color laser printer as exemplified in the aforementioned embodiment. Further, the photoconductive body is not limited to the drum-shaped one as exemplified in the aforementioned embodiment. For instance, the photoconductive body may be formed in a shape of a plate or an endless belt.

Additionally, light sources (e.g., LEDs, electroluminescence devices, and fluorescent substances) other than a laser scanner (for the scanning unit 5) may be employed as light sources for exposing the photoconductive drum 3. In such cases, the “main scanning direction” may be parallel to a direction along which light emitting elements such as LEDs are aligned. Furthermore, aspects of the present invention may be applied to image forming apparatuses employing methods (such as a toner-jet method, an ion flow method, and a multi-stylus electrode method using no photoconductive body) other than the aforementioned electrophotographic method.

The development roller 61 may be spaced away from or in contact with the photoconductive drum 3. Further, the development roller 61 may be spaced away from or in contact with the toner transfer surface TTS.

The voltages generated by the power supply circuits VA, VB, VC, and VD may have an arbitrary waveform (e.g., a sinusoidal waveform and a triangle waveform) other than the rectangle waveform as exemplified in the aforementioned embodiment. Further, in the aforementioned embodiment, the four power supply circuits VA, VB, VC, and VD are provided to generate the four-phase AC voltages with a phase difference of 90 degrees between any adjacent two of the power supply circuits VA, VB, VC, and VD in the aforementioned order. However, three power supply circuits may be provided to generate three-phase AC voltages with a phase difference of 120 degrees between any two of the three power supply circuits.

The configuration and the location of the electric-field transfer board 62 are not limited to those exemplified in the aforementioned embodiment. For example, a portion of the electric-field board 62 around the toner carrying position TCP may be formed in a flat plate shape or a downward-recessed shape along the toner carrying surface 61a that is the circumferential surface of the development roller 61.

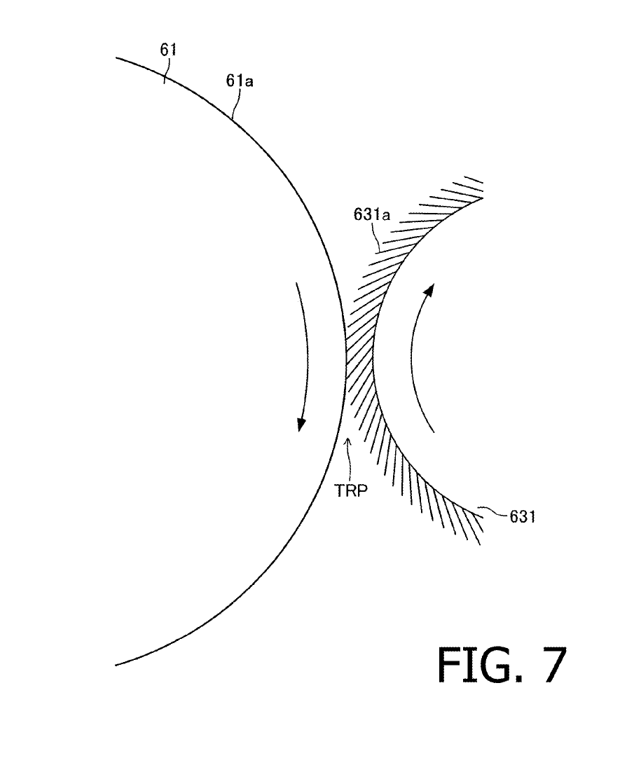

FIG. 7 schematically shows a specific example of a partial configuration, of the toner supply device 6 shown in FIG. 2, around the toner retrieving position TRP. As shown in FIG. 7, the brush roller 631 may be configured such that the fibers 631a are inclined relative to the radial direction, along the moving direction of the toner carrying surface 61a in the toner retrieving position TRP. Thereby, it is possible to reduce a frictional resistance between the fibers 631a and the toner carrying surface 61a in the toner retrieving position TRP. Further, it is possible to prevent the toner T from spattering due to contact with the flicker 632, as effectively as possible.

What is claimed is:

1. A developer supply device configured to supply charged development agent to an intended device, comprising:
a developer carrying body comprising a developer carrying surface that is a cylindrical circumferential surface of the developer carrying body, the developer carrying body being configured to rotate around a rotational axis in such a rotational direction that the developer carrying surface moves in a direction perpendicular to the rotational axis, the developer carrying body being disposed to face the intended device in a developer supply position, so as to supply the development agent carried on the developer carrying surface to the intended device in the developer supply position;
an electric-field transfer unit configured to transfer, by a traveling-wave electric field, the development agent to a developer carrying position upstream relative to the developer supply position in the moving direction of the developer carrying surface, so as to make the developer carrying surface carry the development agent thereon in the developer carrying position; and
a developer retrieving member comprising a plurality of fibers extending from an outer circumferential surface of the developer retrieving member, the developer retrieving member being disposed in such a position that the fibers contact the developer carrying surface in a developer retrieving position downstream relative to the developer supply position in the moving direction of the developer carrying surface, the developer retrieving member being configured to rotate and retrieve the development agent from the developer carrying surface in the developer retrieving position by the fibers moving in contact with the developer carrying surface in response to the rotation of the developer retrieving member.

2. The developer supply device according to claim 1,
wherein the developer retrieving member is configured to rotate in such a rotational direction that the fibers move in a direction opposite to the moving direction of the developer carrying surface in the developer retrieving position.

3. The developer supply device according to claim 2,
wherein the developer retrieving member is configured such that the fibers are inclined relative to a radial direction of the developer retrieving member, along the moving direction of the developer carrying surface in the developer retrieving position.

4. The developer supply device according to claim 1, further comprising a removing member configured to remove, from the developer retrieving member, the development agent retrieved from the developer carrying surface by the developer retrieving member.

5. The developer supply device according to claim 4,
wherein the removing member is configured to contact the fibers, moving in response to the rotation of the developer retrieving member, in a removing position located away from the developer retrieving position and scrape off the development agent held by the fibers.

6. An image forming apparatus comprising:
an image carrying body configured to carry an electrostatic latent image formed thereon; and
a developer supply device configured to supply charged development agent to the image carrying body to develop the electrostatic latent image carried on the image carrying body, the developer supply device comprising:
a developer carrying body comprising a developer carrying surface that is a cylindrical circumferential surface of the developer carrying body, the developer carrying body being configured to rotate around a rotational axis in such a rotational direction that the developer carrying surface moves in a direction perpendicular to the rotational axis, the developer carrying body being disposed to face the image carrying body in a developer supply position, so as to supply the development agent carried on the developer carrying surface to the image carrying body in the developer supply position;
an electric-field transfer unit configured to transfer, by a traveling-wave electric field, the development agent to a developer carrying position upstream relative to the developer supply position in the moving direction of the developer carrying surface, so as to make the developer carrying surface carry the development agent thereon in the developer carrying position; and
a developer retrieving member comprising a plurality of fibers extending from an outer circumferential surface of the developer retrieving member, the developer retrieving member being disposed in such a position that the fibers contact the developer carrying surface in a developer retrieving position downstream relative to the developer supply position in the moving direction of the developer carrying surface, the developer retrieving member being configured to rotate and retrieve the development agent from the developer carrying surface in the developer retrieving position by the fibers moving in contact with the developer carrying surface in response to the rotation of the developer retrieving member.

7. The image forming apparatus according to claim 6,
wherein the developer retrieving member is configured to rotate in such a rotational direction that the fibers move in a direction opposite to the moving direction of the developer carrying surface in the developer retrieving position.

8. The image forming apparatus according to claim 7,
wherein the developer retrieving member is configured such that the fibers are inclined relative to a radial direction of the developer retrieving member, along the moving direction of the developer carrying surface in the developer retrieving position.

9. The image forming apparatus according to claim 6,
wherein the developer supply device further comprises a removing member configured to remove, from the developer retrieving member, the development agent retrieved from the developer carrying surface by the developer retrieving member.

10. The image forming apparatus according to claim 9,
wherein the removing member is configured to contact the fibers, moving in response to the rotation of the developer retrieving member, in a removing position located away from the developer retrieving position and scrape off the development agent held by the fibers.
